(19) United States
(12) Patent Application Publication
(10) Pub. No.: US 2024/0088467 A1
(43) Pub. Date: Mar. 14, 2024

(54) METHODS AND SYSTEMS FOR DISCHARGING SPENT BATTERIES

(71) Applicant: Princeton NuEnergy Inc., Bordentown, NJ (US)

(72) Inventors: Jinyun Liao, Yardley, PA (US); Zhiqian Wang, Florence, NJ (US); Chao Yan, Princeton, NJ (US); Xiaofang Yang, Ambler, PA (US)

(73) Assignee: Princeton NuEnergy Inc., Bordentown, NJ (US)

(21) Appl. No.: 18/464,634

(22) Filed: Sep. 11, 2023

Related U.S. Application Data
(60) Provisional application No. 63/375,070, filed on Sep. 9, 2022.

(51) Int. Cl. H01M 10/54; H01M 4/04; H01M 10/39

(52) U.S. Cl. CPC H01M 10/54; H01M 4/0407; H01M 10/399; H01M 2300/0022; H01M 2300/0028

(57) ABSTRACT

One or more aspects of the present disclosure provide methods for discharging spent batteries. The methods may include coating anode electrodes and cathode electrodes of the spent batteries with at least one catalyst layer. The catalyst layer may facilitate consistent and rapid discharge of the spent batteries. The spent batteries may be processed using an electrolyte solution to discharge the spent batteries. The electrolyte solution may include one or more suitable electrolytes that do not cause electrode corrosion during the discharge of the spent batteries. For example, the electrolytes may include a mixture of Na₃PO₄, water, co-solvent (e.g., ethylene glycol), and at least one surfactant, such as polyoxymethylene glycol octylphenol ethers, dioctyl sodium sulfosuccinate, perfluorooctanesulfonate, etc.

### CROSS-REFERENCE TO RELATED APPLICATIONS

This application claims the benefit of U.S. Provisional Patent Application No. 63/375,070, entitled “METHOD OF AGED BATTERY SAFE DISCHARGE AND OPERATION THEREOF,” filed Sep. 9, 2022, which is hereby incorporated by reference herein in its entirety.

### STATEMENT REGARDING FEDERALLY SPONSORED RESEARCH

This invention was made with government support under Grant DE-SC0020868 awarded by the Department of Energy. The government has certain rights in the invention.

### TECHNOLOGY FIELD

The present application generally relates to battery recycling, and more particularly to discharging spent batteries, such as aged lithium-ion batteries (LIBs).

### BACKGROUND

Lithium-ion batteries (LIBs) are widely used in many electrical devices, vehicles, etc. Spent LIBs may result in environmental problems and resource waste. End-of-life LIBs may become important secondary sources for various materials used in the production of new batteries. Consequently, there is surging demand for lithium, graphite, cobalt, and nickel, potentially surpassing the supply of these raw materials. This has intensified interest in the development of technologies for recycling and recovering these metals from secondary sources, particularly spent batteries. Recycling addresses both environmental regulations and resource conservation concerns. It can also mitigate the environmental impact associated with virgin metal extraction, raw material transportation, and energy consumption. Additionally, recycling stabilizes cost dynamics and ensures a consistent supply of essential materials. Nonetheless, safely handling aged batteries during storage and transport is challenging. Numerous reported fire incidents can be traced back to insufficient safety measures, resulting in the unintended self-charging of these batteries. Effective deactivation technology for aged batteries must address two primary concerns: deep (or total) discharge and large-scale processing capability. Traditional discharge methods using salt solution (NaCl) not only corrode battery electrode connectors but are also inefficient at discharging the batteries.

Transporting spent lithium-ion batteries, especially high-energy ones used in electric traction or other high-power applications, poses risks. These batteries, often in an uncertain state of charge, can endanger individuals, particularly if they are still partially charged. Direct contact with live parts due to surges can lead to serious or even fatal injuries.

Additionally, there's a heightened risk of fire and explosion. Lithium batteries contain not just lithium or its compounds, but also organic materials; the battery casing often comprises plastics. If these batteries are damaged—a common occurrence with recycled items—there's a significant hazard potential. Exposure of lithium to oxygen or moisture can trigger a reaction, producing hydrogen or other flammable gases, accompanied by intense heat. Damage to the battery cells or stacks, as seen with short circuits, can further increase the heat. This heat can ignite the produced gases or the battery's organic compounds, especially the plastic casing. Without internal heat generation, the released flammable gases can still ignite or explode externally. For instance, in post-automotive accidents, if the battery's active material contacts a liquid, such as an electrolyte, volatile and uncontrolled chemical reactions can generate explosive gas mixtures. To date, no technology guarantees the safe deactivation, storage, and transport of high-energy batteries.

Current methods often result in an incomplete discharge of lithium batteries. Full discharge is essential before storing and transporting these used batteries from collection points to recycling facilities. A major challenge in this process is the non-standardized terminals. Furthermore, the sheer volume of aged batteries, numbering in the tens of millions annually, renders resistive electrical discharge impractical. In some instances, even previously discharged batteries can recharge over time, reintroducing risks during subsequent transport.

Presently, aged batteries are stored and transported in steel or plastic containers equipped with thermal insulation and fire-suppression capabilities. Each cell or module also requires specialized insulation to prevent short-circuiting during transport. These added protective measures complicate the handling process and render it economically unviable.

Therefore, there is a pressing need for a refined battery discharge process.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

According to one or more aspects of the present disclosure, methods for discharging spent batteries are provided. The methods may include: coating anode electrodes and cathode electrodes of the spent batteries with at least one catalyst layer; and processing the spent batteries with the coated catalyst layer using an electrolyte solution to electrochemically discharge the spent batteries.

In some embodiments, processing the spent batteries with the coated catalyst layer using the electrolyte solution includes electrolyzing the electrolyte solution.

In some embodiments, the methods further include generating a turbulent flow of electrolytes using an electrolyte circulation system.

In some embodiments, the methods further include collecting hydrogen produced during the processing of the spent batteries using the electrolyte solution.

In some embodiments, coating the anode electrodes and the cathode electrodes of the spent batteries with the catalyst layer includes spraying a mixture of a catalyst precursor and a solvent.

In some embodiments, the catalyst precursor includes at least one of a Ni salt, a Hf salt, a Zr salt, a Ti salt, a V salt, a Mn salt, a Fe salt, or a Cu salt.

In some embodiments, the solvent includes at least one of water, ethanol, methanol, isopropanol, or ethylene glycol.

In some embodiments, the electrolyte solution includes a mixture of a less corrosive alkali salt, a solvent, and a surfactant.

In some embodiments, the less corrosive alkali salt includes at least one of NaCl, MgSO₄, Na₂HPO₄, NaH₂PO₄, K₂HPO₄, or KH₂PO₄.

In some embodiments, the solvent includes at least one of water, ethanol, methanol, isopropanol, or ethylene glycol.

In some embodiments, the surfactant includes at least one of polyoxyethylene glycol octylphenol ethers, polyoxyethylene glycol alkylphenol ethers, polyoxyethylene glycol sorbitan alkyl esters, dioctyl sodium sulfosuccinate, perfluorooctanesulfonate, or linear alkylbenzene sulfonates.

According to one or more aspects of the present disclosure, a system for discharging spent batteries is provided. The system may include: a catalyst coating component to coat anode electrodes and cathode electrodes of the spent batteries with at least one catalyst layer; and a battery discharge component to process the spent batteries with the coated catalyst layer using an electrolyte solution.

In some embodiments, the battery discharge component processes the spent batteries with the coated catalyst layer using the electrolyte solution by electrolyzing the electrolyte solution.

In some embodiments, the system further includes an electrolyte circulation system generating a turbulent flow of electrolytes using an electrolyte circulation system.

In some embodiments, the system further includes a gas collection component to collect hydrogen produced during the processing of the spent batteries using the electrolyte solution.

In some embodiments, to coat the anode electrodes and the cathode electrodes of the spent batteries with the catalyst layer, the catalyst coating component is to spray a mixture of a catalyst precursor and a solvent.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding.

FIG. 1 is a block diagram illustrating a system for discharging spent batteries in accordance with some embodiments of the present disclosure.

FIG. 2A is a schematic diagram illustrating an example catalyst coating system for performing catalyst coating in accordance with some embodiments of the present disclosure.

FIG. 2B shows a 3D view of a container including spent batteries with coated catalyst layers.

FIG. 3 is a schematic diagram illustrating an example system for battery discharge in accordance with some embodiments of the present disclosure.

FIG. 4 is a schematic diagram illustrating an example system for battery discharge in accordance with some embodiments of the present disclosure.

FIG. 5 is a flow diagram illustrating an example method for discharging spent batteries in accordance with some embodiments of the present disclosure.

### DETAILED DESCRIPTION

The present disclosure provides mechanisms (e.g., systems, apparatuses, methods, etc.) for discharging spent batteries. As referred to herein, a battery may be any electric storage device. In some embodiments, the battery may be a lithium-ion battery (LIB). Spent batteries may include used and/or aged LIBs, battery modules, battery packs, etc.

Spent batteries must be discharged before they can be safely stored, transported, and disassembled for recycling or upcycling. It might be impractical to use a resistance discharge circuit for discharging large volumes of aging batteries and battery modules. Electrochemical discharge may be utilized to efficiently handle many batteries in a short timeframe. For example, spent batteries may be placed in a salt bath, allowing the remaining electrical energy within the spent batteries to drive the water electrolysis reaction. When the anode and cathode of a battery contact salt-containing water, the potential difference between the poles triggers the water's electrolysis, thereby discharging the spent battery.

Water electrolysis involves breaking down water molecules into hydrogen and oxygen gases using electric force. During electrochemical discharge in aqueous solutions, certain reactions may result in gas production and the consumption of the cell's electrons. Consequently, O₂ and H₂ are generated at the battery's cathode anode and anode electrode, respectively. However, the materials used for these electrodes are not specifically designed for water electrolysis. As a result, electrode corrosion may occur during the electrochemical discharge of the spent battery, which can lead to the development of a non-conductive passive oxide layer on the anode, thereby hindering the complete discharge of the spent battery.

According to one or more aspects of the present disclosure, spent batteries may be electrochemically discharged in aqueous solutions containing a suitable electrolyte that does not cause electrode corrosion during the discharge of the spent batteries. This electrolyte may include, for example, a formulation of inorganic salts and organic additives. An example of such an electrolyte is a mixture of Na₃PO₄, water, co-solvent (e.g., ethylene glycol), and at least one surfactant, such as polyoxymethylene glycol octylphenol ethers, dioctyl sodium sulfosuccinate, perfluorooctanesulfonate, etc. During the electrochemical discharge of the spent batteries utilizing the electrolyte, a protective ultra-thin layer may be formed on the surface of the electrodes of the spent batteries.

According to one or more aspects of the present disclosure, a catalyst layer may be formed on both the cathode electrodes and the anode electrode of the spent batteries prior to the electrochemical discharge of the spent batteries. The catalyst layer may facilitate consistent and rapid discharge of the spent batteries. The mechanisms described herein further integrate an electrochemical-fluidic dynamic process into the electrochemical discharge of the spent batteries, which may increase the processing efficiency and safety by efficiently removing H₂ and O₂ gases generated during the electrochemical process.

The mechanisms for battery discharging as described herein may be implemented at ambient temperatures using minimal chemicals, leading to a reduction in both capital investment and operating expenses. Such mechanisms described herein may be especially beneficial for processing aged lithium-ion batteries and may handle large volumes of old LIBs effectively. Additionally, the mechanisms described herein may offer an economical recycling solution for spent lithium-ion batteries, reducing environmental footprint, fire risk, and chemical use. They may be suitable for deactivating both current lithium-ion and future lithium metal batteries, sodium-ion batteries, lithium sulfur batteries, and solid-state batteries, ensuring optimal recycling costs and limited chemical use. They may also be utilized to ensure the safe transportation and storage of aged lithium-ion batteries and other battery types.

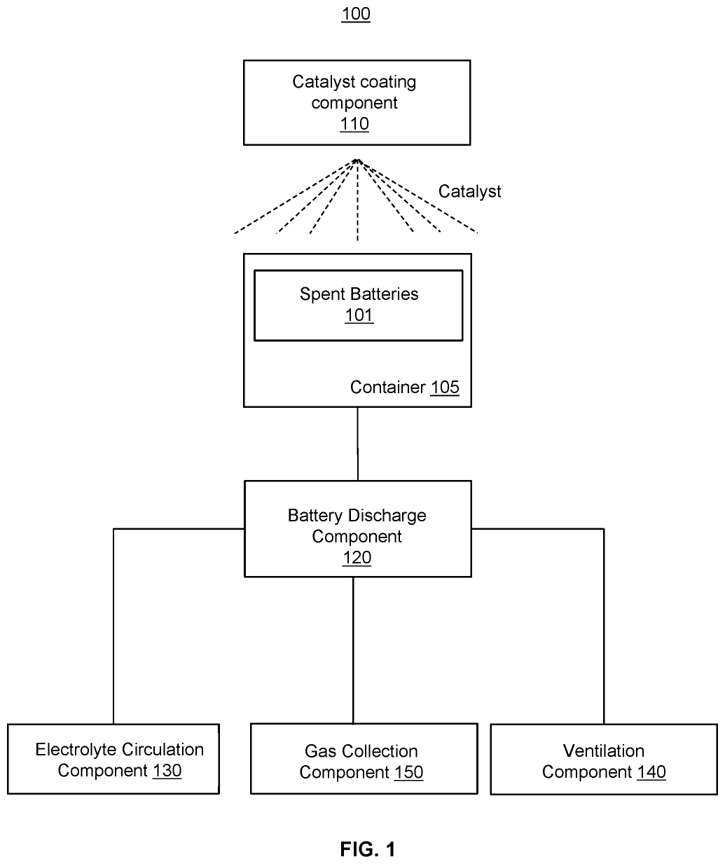

FIG. 1 is a schematic diagram illustrating an example system 100 for discharging spent batteries. As shown, system 100 may include a catalyst coating component 110, a battery discharge component 120, an electrolyte circulation component 130, a ventilation component 140, a gas collection component 150, and/or any other suitable component for performing the battery discharging mechanisms described herein. Spent batteries 101 may be loaded into one or more containers 105 for processing. System 100 may include more or fewer modules without loss of generality. For example, two of the modules may be combined into a single module, or one of the modules may be divided into two or more modules.

The catalyst coating component 110 may coat anode electrodes and/or cathode electrodes of the spent batteries 101 with one or more catalysts that may accelerate the kinetics of water electrolysis and reduce the discharge time (e.g., from days to hours). The catalysts may also reduce the over-potential of water electrolysis, thereby allowing the battery to discharge more efficiently and completely. As an example, the catalysts may include a mixture of nickel and other transition metal oxides (Hf, Zr, Ti, V, Mn, Fe, Cu, etc.). In some embodiments, a catalyst layer may be coated on both the cathode electrode connectors and the anode electrode connectors of the spent batteries.

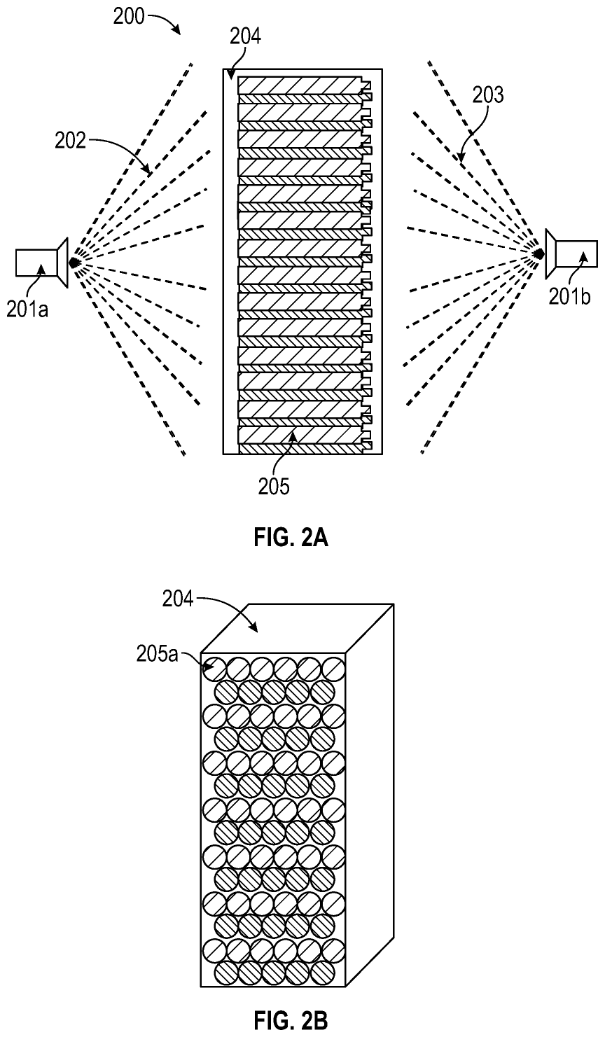

In some embodiments, the catalyst coating component 110 may spray a mixture of a catalyst precursor and a solvent to cover the surfaces of the electrodes with a layer of corrosion-resistant oxide. The catalyst precursor may include, for example, one or more salts containing Ni, Hf, Zr, Ti, V, Mn, Fe, Cu, etc. (e.g., a Ni salt, a Hf salt, a Zr salt, a Ti salt, a V salt, a Mn salt, a Fe salt, a Cu salt, etc.). The solvent may include, for example, water, ethanol, methanol, isopropanol, ethylene glycol, etc. As an example, the catalyst coating component 110 may include a catalyst coating system 200 as described in connection with FIG. 2A below.

In some embodiments, prior to the catalyst coating, the spent batteries may be loaded into the container(s) 105 in an ordered arrangement, so that the anode electrodes of the spent batteries are aligned with each other, and the cathode electrodes of the spent batteries are aligned with each other (e.g., as shown in FIG. 2A.)

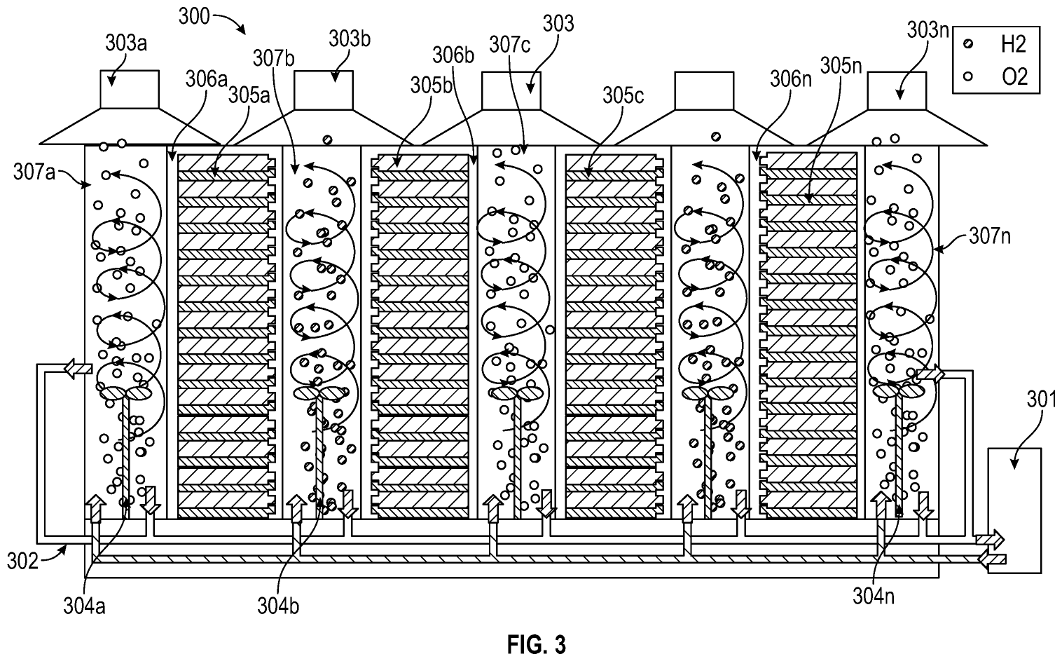

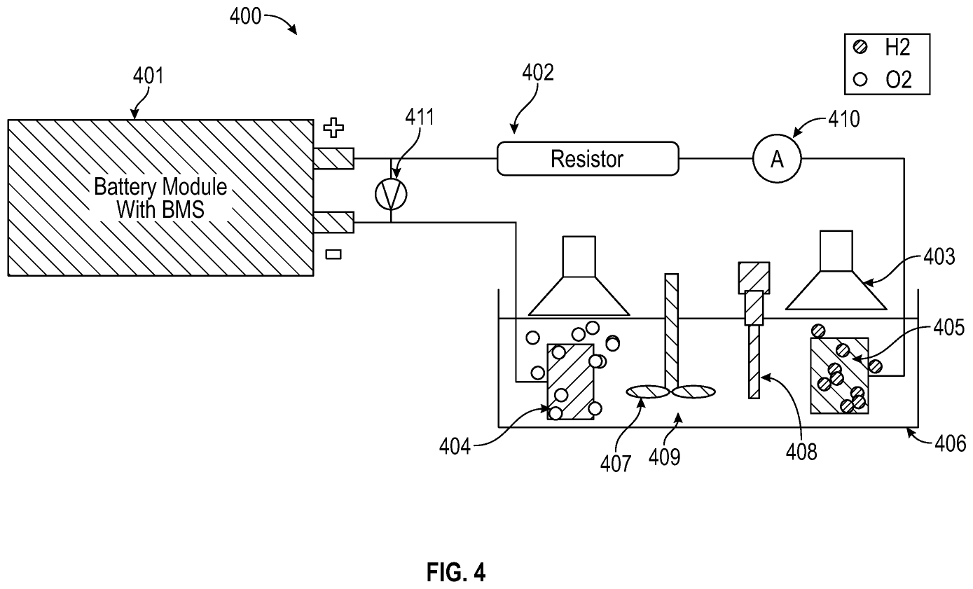

The battery discharge component 120 may process the spent batteries using an electrolyte solution to electrochemically discharge the spent batteries. For example, the anode materials and the cathode materials of the spent batteries may be connected to a first electrode (e.g., an H-electrode) and a second electrode (e.g., an O-electrode) of the battery discharge component 120, respectively. The first electrode and the second electrode may be immersed in the electrolyte solution. The spent batteries may then be discharged by electrolyzing the electrolyte solution. In some embodiments, the battery discharge component 120 may include systems 300 and/or 400 as described in connection with FIGS. 3-4 and/or one or more components of systems 300 and/or 400. In some embodiments, the spent batteries are processed by battery discharge component 120 after the catalyst coating process.

The electrolyte solution may include a mixture of one or more alkali salts, a solvent, and a surfactant. The alkali salts may be products of a weak base and weak acid with pH between 6 and 8 in aqueous (also referred to as “less corrosive alkali salts”). The less corrosive alkali salts may include, for example, one or more NaCl, Na₂S, MgSO₄, Na₂CO₃, Na₃PO₄, Na₂HPO₄, NaH₂PO₄, K₃PO₄, K₂HPO₄, KH₂PO₄, etc. The solvent may include one or more water, ethanol, methanol, isopropanol, ethylene glycol, etc. The surfactant may include one or more polyoxyethylene glycol octylphenol ethers, polyoxyethylene glycol alkylphenol ethers, polyoxyethylene glycol sorbitan alkyl esters, dioctyl sodium sulfosuccinate, perfluorooctanesulfonate, linear alkylbenzene sulfonates, etc. The amount of each component of the electrolyte solution can be adjusted to achieve a certain pH of the solution from 4 to 12, depending on the nature of the battery electrode material (stainless steel, alumina, copper, or nickel). For example, the concentration of Na₃PO₄ is from 1 wt. % to 50 wt. %, the volume ratio of ethylene glycol to water is from 1:1000 to 1:1, and the concentration of the surfactant is from 0.05 wt. % to 10 wt. %. Processing the spent batteries using the electrolyte solution may form a protective ultra-thin layer on the surfaces of the electrodes of the spent batteries.

The electrolyte circulation component 130 may generate a turbulent flow of electrolytes. For example, the electrolyte circulation component 130 may include one or more electrolyte stirrers (e.g., electrolyte stirrer 407 of FIG. 4) that may stir the electrolyte solution, one or more ultrasonic probes (e.g., ultrasonic probe 408 of FIG. 4) that may cause continuous motion of the electrolyte solution by ultrasonication, etc. The electrolyte circulation component 130 may further remove H₂ and O₂ gas bubbles produced during the electrolysis of the electrolyte solution so that the local concentration of O₂ on the surface of the cathode connector cannot rise to a damaging level for the cathode connector materials (e.g., Al, Cu, Ni, and stainless steel). Meanwhile, the corrosive materials may be removed by the flowing electrolyte so that the fresh and highly active surface is exposed to the electrolyte for a fast electrochemical reaction.

The ventilation component 140 may be connected to the battery discharge component 120 to reduce the local H₂ concentrations to a safe level (<4,100 ppm in air).

In some embodiments, the system 100 may further include a gas collection component 150 that may collect H₂ for further use. For example, the gas collection component 150 may filter H₂ from the mixture of O₂ and H₂ produced by the electrolysis of the electrolyte solution and may include a gas collection hood to collect the H₂ gas. The gas collection component 150 may include, for example, a gas collection system 303 as described in connection with FIG. 3. In some embodiments, the operation temperature of system 100 may be between about 20° C. and about 80° C.

FIG. 2A is a schematic diagram illustrating an example catalyst coating system 200 for performing catalyst coating in accordance with some embodiments of the present disclosure.

As shown, spent batteries 205 may be loaded in a container 204 for catalyst coating. The spent batteries 205 may be arranged so that the cathode electrodes of the battery cells are aligned with each other and that the anode electrodes of the battery cells are aligned with each other. One or more first spray nozzles 201a may spray hydrogen reduction reaction (HRR) catalyst 202 on cathode electrodes of spent batteries 205. An HRR catalyst, such as platinum, iridium, etc. is an electrocatalyst participating in a hydrogen reduction reaction to facilitate electrochemical processes and produce H₂. One or more second spray nozzles 201b may coat oxygen evolution reaction (OER) catalyst 203 the anode electrodes of the spent batteries 205. An OER catalyst, such as IrO₂, RuO₂, base metal oxides, base metal sulfides, base metal phosphide, etc. is an electrocatalyst participating in oxygen evolution reaction to facilitate electrochemical processes and produce O₂.

In some embodiments, the first spray nozzle(s) 201a and/or the second spray nozzle(s) 201b may be an aerosol spray that may create an aerosol mist of liquid particles to coat a thin layer on substrates. An example of such a spray solution is a mixture of an alkali salt precursor as an active material (e.g., Ni(NO3)2) and a solvent as a dispersion medium (e.g., water, ethanol, etc.). The concentration of the alkali precursor may be from 1 wt. % to 50 wt. %.

In some embodiments, the catalysts 202 and 203 may cover the surfaces of the anode electrodes and the cathode electrodes of the spent batteries 205 and may form one or more oxide layers on the anode electrodes and the cathode electrodes of the spent batteries 205. The thickness of the oxide layer may be between about 10 nm and about 1000 nm. The oxide layer may be resistant to alkali and have high activity for catalyzing water electrolysis. In some embodiments, coated catalysts (e.g., the oxide layer) may include a mixture of nickel and other transition metal oxides (Hf, Zr, Ti, V, Mn, Fe, Cu, etc.). The coated catalyst can accelerate the kinetics of water electrolysis and reduce the discharge time from days to hours. The coated catalysts may also reduce the over-potential of water electrolysis, thereby allowing the battery to discharge more completely.

FIG. 2B shows a 3D view of container 204 spent batteries 205a with a catalyst coating layer. As shown in FIGS. 2A-2B, the spent batteries are loaded into container 204 in an ordered arrangement (e.g., with aligned anode electrodes and aligned cathode electrodes). This arrangement may enable better electrolyte circulation during the discharge of the spent batteries.

FIG. 3 is a schematic diagram illustrating an example system 300 for battery discharging in accordance with some embodiments of the present disclosure.

As shown, system 300 may include a circulation pump 301, a circulation and filtration system 302, a gas collection system 303 (including one or more gas collection hoods 303a, 303b, . . . , 303n), electrolyte stirrers 304a, 304b, . . . , 304n, one or more battery containers 306a, 306b, . . . , 306n, and electrolyte containers 307a, 307b, . . . , 307n. While a certain number of battery containers and electrolyte containers are shown in FIG. 3, this is merely illustrative. System 300 may include any suitable number of battery containers and/or electrolyte containers for processing a desirable volume of spent batteries.

Spent batteries 305a, . . . , 305n may be loaded into containers 306a, . . . , 306n, respectively, for discharging. Each of the spent batteries 305a-n may include multiple battery cells that are arranged in a suitable manner (e.g., with aligned anode electrodes and aligned cathode electrodes). In some embodiments, spent batteries 305a, . . . , 305n may be coated with one or more catalyst layers before being processed by system 300. The electrolyte containers 307a-n may contain suitable electrolytes for electrochemically discharging the spent batteries 305a-n. As shown, the cathode electrodes of the spent batteries loaded in neighboring battery containers may contact the electrolyte solution in the same electrolyte container for discharging. Similarly, the anode electrodes of the spent batteries loaded in neighboring battery containers may contact the electrolyte solution in the same electrolyte container for discharging. For example, the anode electrodes of the spent batteries 305a and the anode electrodes of the spent batteries 305b may contact the electrolyte solution in the electrolyte container 307b. During the discharge of the spent batteries 305a and 305b, hydrogen may be generated in the electrolyte container 307b. As another example, the cathode electrodes of the spent batteries 305b and the cathode electrodes of the spent batteries 305c may contact the electrolyte solution in the electrolyte container 307c. During the discharge of the spent batteries 305b and 305c, oxygen may be generated in the electrolyte container 307c. The arrangement of the spent batteries as shown in FIG. 3 may further improve the efficiency of the discharge of the spent batteries in batches and may facilitate the collection of the gas produced during the discharge of the spent batteries.

The electrolyte stirrers 304a-n may stir the electrolyte solutions in the electrolyte containers 307a-n and may generate a turbulent flow of electrolytes. This constant flow motion of the electrolytes may facilitate the removal of gas bubbles of H₂ and O₂ and may prevent the local concentration of O₂ on the surface of the cathode electrodes of the spent batteries from rising to a damaging level for the cathode materials (e.g., Al, Cu, Ni, and stainless steel). Meanwhile, corrosive materials on the cathode materials of the spent batteries may be removed by the flowing electrolyte so that the fresh and highly active surface is exposed to the electrolyte for a fast electrochemical reaction. In some embodiments, the circulation pump 301 and the circulation and filtration system 302 may remove debris produced during the discharge of the spent batteries from the electrode and the electrolyte solution.

The gas collection system 303 may collect gas produced during the discharge of the spent batteries (e.g., hydrogen, oxygen, etc.). For example, the gas collection hood 303a may collect the oxygen generated in the electrolyte container 307a. The gas collection hood 303b may collect the hydrogen generated in the electrolyte container 307b during the discharge of the spent batteries 305a and 305b and may thus reduce the local H₂ concentrations to a safe level. The collected H₂ may be stored for further use.

FIG. 4 is a schematic diagram illustrating an example system 400 for battery discharging in accordance with some embodiments of the present disclosure. System 400 may discharge spent battery modules and/or packs with a battery management system (BMS), such as a battery module 401. A battery module may include a set of battery cells that are connected together or encapsulated within an outer casing to protect the battery cells against external impact. Such battery module may be used either stand-alone or in combination with other battery modules. A battery pack may include a set of any number of battery modules and/or battery cells configured in a series, parallel or a mixture of both to deliver the desired voltage, capacity, or power density. System 400 may include an electric resistor 402, a gas collection system 403, a first electrode (also referred to as the “H-electrode”) 404, a second electrode (also referred to as the “O-electrode”) 405, an electrolyte bath 406, an electrolyte stirrer 407, an ultrasonic probe 408, electrolyte 409, a current meter 410, a voltage meter 411, and/or any suitable component for discharging spent battery modules/packs in accordance with the present disclosure. A current meter 410 is an oceanographic device for flow measurement by mechanical, tilt, acoustical, or electrical means. A voltage meter or voltmeter 411 is an instrument for measuring electric potential difference between two points in an electric circuit.

As shown, the anode materials and the cathode materials of the battery module 401 may be connected to the anode electrode 404 and the cathode electrode 405, respectively. The anode electrode 404 and the cathode electrode 405 may be immersed in a salt bath to electrolyze water for discharging the battery module/pack 401. The electrolyte stirrer 407 and the ultrasonic probe 408 may cause continuous motion of the electrolyte by stirring and/or ultrasonication, which may remove H₂ and O₂ gas bubbles produced during the electrolysis of the electrolyte solution. This may ensure that the local concentration of O₂ on the cathode electrode's surface does not rise to a level that could damage the cathode materials (e.g., Ir, Ru, Pt, Ni, Cu) of the battery module/pack 401. In addition, the flow of the electrolyte may remove small amounts of corrosive materials, exposing a fresh and highly active surface to the electrolyte for rapid electrochemical reactions. A gas collection component 403 may be connected to the discharge device to keep local H₂ concentrations at a safe level. This system can be enhanced to capture the H₂ gas. For example, an H₂ membrane can be used to separate H₂ gas from the mixture.

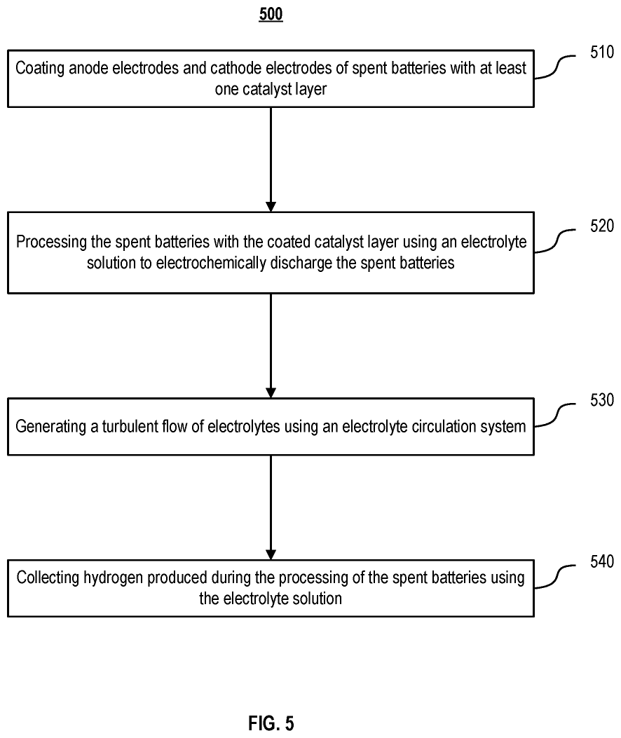

FIG. 5 is a flow diagram illustrating an example method 500 for discharging spent batteries in accordance with some embodiments of the present disclosure. Method 500 may be implemented using the systems for discharging spent batteries as described in connection with FIGS. 1-4.

At 510, anode electrodes and/or cathode electrodes of the spent batteries may be coated with at least one catalyst layer. For example, a mixture of a catalyst precursor and a solvent may be sprayed on the anode electrodes and the cathode electrodes of the spent batteries to form the catalyst layer. The catalyst precursor may include, for example, a Ni salt, a Hf salt, a Zr salt, a Ti salt, a V salt, a Mn salt, a Fe salt, a Cu salt, etc. The solvent may include, for example, water, ethanol, methanol, isopropanol, ethylene glycol, etc. In some embodiments, the anode electrodes and the cathode electrodes of the spent batteries may be coated using the catalyst coating component 110 of FIG. 1 and/or the catalyst coating system 200 of FIG. 2A.

At 520, the spent batteries may be processed using an electrolyte solution to electrochemically discharge the spent batteries. The spent batteries may be processed after the catalyst coating is performed at 510. The electrolyte solution may include a mixture of an alkali salt, a solvent, and a surfactant, wherein the alkali salt comprises at least one of NaCl, Na₂S, MgSO₄, Na₂CO₃, Na₃PO₄, Na₂HPO₄, NaH₂PO₄, K₃PO₄, K₂HPO₄, KH₂PO₄, etc. The solvent may include, for example, water, ethanol, methanol, isopropanol, ethylene glycol, etc. The surfactant may include, for example, polyoxyethylene glycol octylphenol ethers, polyoxyethylene glycol alkylphenol ethers, polyoxyethylene glycol sorbitan alkyl esters, dioctyl sodium sulfosuccinate, perfluorooctanesulfonate, linear alkylbenzene sulfonates, etc.

In some embodiments, the spent batteries may be loaded in one or more battery containers for electrochemical discharge. As described in connection with FIG. 2, the battery cells of the battery spent batteries may be arranged so that the anode electrodes of the battery cells are aligned with each other and that the cathode electrodes of the battery cells are aligned with each other. In some embodiments, the spent batteries may be loaded into multiple battery containers for batch processing. For example, as described in connection with FIG. 3 above, the spent batteries may be loaded in multiple battery containers separated by multiple electrolyte containers. Each of the electrolyte containers may include suitable electrolytes and/or electrolyte solutions for electrochemical discharge of the spent batteries. The cathode electrodes of the spent batteries loaded in adjacent battery containers may be processed by the electrolyte solution in an electrolyte container. Similarly, the anode electrodes of the spent batteries in adjacent battery containers may be processed by the electrolyte solution in another electrolyte container.

At 530, a turbulent flow of electrolytes using an electrolyte circulation system. For example, one or more electrolyte stirrers (e.g., electrolyte stirrer 407 of FIG. 4) may stir the electrolyte solution. As another example, one or more ultrasonic probes (e.g., ultrasonic probe 408 of FIG. 4) may cause continuous motion of the electrolyte solution by ultrasonication, etc.

At 540, hydrogen produced during the processing of the spent batteries using the electrolyte solution may be collected. For example, a ventilation component and/or a gas collection component may filter H₂ from the mixture of O₂ and H₂ produced by the electrolysis of the electrolyte solution and may collect the H₂ gas for further use.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events.

The terms “approximately,” “about,” and “substantially” may be used to mean within ±20% of a target dimension in some embodiments, within ±10% of a target dimension in some embodiments, within ±5% of a target dimension in some embodiments, and yet within ±2% in some embodiments. The terms “approximately” and “about” may include the target dimension.

In the foregoing description, numerous details are set forth. It will be apparent, however, that the disclosure may be practiced without these specific details. In some instances, well-known structures and devices are shown in block diagram form, rather than in detail, in order to avoid obscuring the disclosure.

The terms “first,” “second,” “third,” “fourth,” etc. as used herein are meant as labels to distinguish among different elements and may not necessarily have an ordinal meaning according to their numerical designation.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Reference throughout this specification to “an implementation” or “one implementation” means that a particular feature, structure, or characteristic described in connection with the implementation is included in at least one implementation. Thus, the appearances of the phrase “an implementation” or “one implementation” in various places throughout this specification are not necessarily all referring to the same implementation.

Whereas many alterations and modifications of the disclosure will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as the disclosure.

What is claimed is:

1. A method for discharging spent batteries, comprising:
coating anode electrodes and cathode electrodes of the spent batteries with at least one catalyst layer; and
processing the spent batteries with the coated catalyst layer using an electrolyte solution to electrochemically discharge the spent batteries.

2. The method of claim 1, wherein processing the spent batteries with the coated catalyst layer using the electrolyte solution comprises electrolyzing the electrolyte solution.

3. The method of claim 1, further comprising generating a turbulent flow of electrolytes using an electrolyte circulation system.

4. The method of claim 1, further comprising:
collecting hydrogen produced during the processing of the spent batteries using the electrolyte solution.

5. The method of claim 1, wherein coating the anode electrodes and the cathode electrodes of the spent batteries with the at least one catalyst layer comprises spraying a mixture of a catalyst precursor and a solvent.

6. The method of claim 5, wherein the catalyst precursor comprises at least one of a Ni salt, a Hf salt, a Zr salt, a Ti salt, a V salt, a Mn salt, a Fe salt, or a Cu salt.

7. The method of claim 6, wherein the solvent comprises at least one of water, ethanol, methanol, isopropanol, or ethylene glycol.

8. The method of claim 1, wherein the electrolyte solution comprises a mixture of a less corrosive alkali salt, a solvent, and a surfactant, wherein the less corrosive alkali salt comprises at least one of NaCl, MgSO₄, Na₂HPO₄, NaH₂PO₄, K₂HPO₄, or KH₂PO₄.

9. The method of claim 8, wherein the solvent comprises at least one of water, ethanol, methanol, isopropanol, or ethylene glycol.

10. The method of claim 8, wherein the surfactant comprises at least one of polyoxyethylene glycol octylphenol ethers, polyoxyethylene glycol alkylphenol ethers, polyoxyethylene glycol sorbitan alkyl esters, dioctyl sodium sulfosuccinate, perfluorooctanesulfonate, or linear alkylbenzene sulfonates.

11. A system for discharging spent batteries, comprising:
a catalyst coating component to coat anode electrodes and cathode electrodes of the spent batteries with at least one catalyst layer; and
a battery discharge component to process the spent batteries with the coated catalyst layer using an electrolyte solution.

12. The system of claim 11, wherein the battery discharge component processes the spent batteries with the coated catalyst layer using the electrolyte solution by electrolyzing the electrolyte solution.

13. The system of claim 11, further comprising an electrolyte circulation system generating a turbulent flow of electrolytes using an electrolyte circulation system.

14. The system of claim 11, further comprising:
a gas collection component to collect hydrogen produced during the processing of the spent batteries using the electrolyte solution.

15. The system of claim 11, wherein, to coat the anode electrodes and the cathode electrodes of the spent batteries with the at least one catalyst layer, the catalyst coating component is to spray a mixture of a catalyst precursor and a solvent.

16. The system of claim 15, wherein the catalyst precursor comprises at least one of a Pt salt, Ir salt, Ni salt, a Hf salt, a Zr salt, a Ti salt, a V salt, a Mn salt, a Fe salt, or a Cu salt.

17. The system of claim 16, wherein the solvent comprises at least one of water, ethanol, methanol, isopropanol, or ethylene glycol.

18. The system of claim 11, wherein the electrolyte solution comprises a mixture of an alkali salt, a solvent, and a surfactant, wherein the alkali salt comprises at least one of NaCl, Na₂S, MgSO₄, Na₂CO₃, Na₃PO₄, Na₂HPO₄, NaH₂PO₄, K₃PO₄, K₂HPO₄, or KH₂PO₄.

19. The system of claim 18, wherein the solvent comprises at least one of water, ethanol, methanol, isopropanol, or ethylene glycol.

20. The system of claim 18, wherein the surfactant comprises polyoxyethylene glycol octylphenol ethers, polyoxyethylene glycol alkylphenol ethers, polyoxyethylene glycol sorbitan alkyl esters, dioctyl sodium sulfosuccinate, perfluorooctanesulfonate, or linear alkylbenzene sulfonates.
